(19) United States
(12) Patent Application Publication
(10) Pub. No.: US 2025/0276720 A1
(43) Pub. Date: Sep. 4, 2025

(54) METHOD AND DEVICE FOR HANDLING EXTERNAL ABNORMALITY IN AUTONOMOUS DRIVING SYSTEM

(71) Applicant: SEOUL NATIONAL UNIVERSITY R&DB FOUNDATION, Seoul (KR)

(72) Inventors: Chang-Gun LEE, Seoul (KR); Jihwan KIM, Seoul (KR); Wan CHOI, Seoul (KR)

(73) Assignee: SEOUL NATIONAL UNIVERSITY R&DB FOUNDATION, Seoul (KR)

(21) Appl. No.: 19/058,240

(22) Filed: Feb. 20, 2025

(30) Foreign Application Priority Data
Feb. 29, 2024 (KR) 10-2024-0030028
Mar. 25, 2024 (KR) 10-2024-0040288

(51) Int. Cl. B60W 60/00; B60W 50/02; G01C 21/34

(52) U.S. Cl. CPC B60W 60/00186; B60W 50/0205; G01C 21/3415; B60W 2050/0215

(57) ABSTRACT

A method of handling an external abnormality in an autonomous driving system, performed in a device including a memory and a processor electrically connected to the memory, includes collecting physical situation information outside an autonomous vehicle from at least one sensor installed in the autonomous vehicle through the processor, repeatedly performing a physical situation perception operation for a preset critical time through the processor, selecting one of a plurality of operation modes according to a result of the physical situation perception operation and generating a route plan for the autonomous vehicle through the processor, and controlling driving of the autonomous vehicle according to the route plan through the processor.

### CROSS-REFERENCE TO RELATED PATENT APPLICATION

This application claims the benefit of Korean Patent Application Nos. 10-2024-0040288, filed on Mar. 25, 2024, and 10-2024-0030028, filed on Feb. 29, 2024, in the Korean Intellectual Property Office, the disclosure of which is incorporated herein in its entirety by reference.

### TECHNICAL FIELD

The present disclosure relates to technology for handling an external abnormality, and more specifically, to a technique for ensuring minimum safety in a situation in which external physical situation perception has failed which may occur in an autonomous driving system.

### BACKGROUND

An autonomous driving system is an automobile system for autonomous driving without driver intervention, and is technology for recognizing a surrounding environment, planning a driving route, and driving safely by utilizing various sensors, artificial intelligence, and communication technologies. An autonomous driving system may include sensor technology for collecting information on surrounding environments using various sensors, artificial intelligence technology for recognizing surrounding environments and identifying risk factors by using deep learning and computer vision, and control technology for controlling a vehicle according to a route plan.

Physical situation perception refers to a process by which an autonomous driving system accurately perceives and understands a surrounding environment, which can play an essential role in securing the safety and efficiency of an autonomous driving system. That is, physical situation perception enables safe driving by accurately recognizing surrounding vehicles, pedestrians, road conditions, and traffic lights, and enables selection of a safe and efficient route by recognizing abnormal situations such as road sinking, illegal parking, and crosswalk violations.

For physical situation perception, it may be important to generate accurate and reliable information by fusing various types of sensor data collected from sensors, and to this end, it is necessary to improve accuracy, real-time processing speed, and safety.

### PRIOR ART DOCUMENT

### [Patent Document]

Korean Patent Publication No. 10-2587244 (2023.10.04)

### SUMMARY

An object of one embodiment of the present disclosure is to provide a technique for ensuring minimum safety in a situation in which external physical situation perception has failed which may occur in an autonomous driving system. In particular, an object of the present disclosure is to ensure minimum safety such that autonomous driving can be performed even in unpredictable situations, such as cases in which target accuracy is not reached despite a sufficient number of repetitions in situations that were not predicted during a design phase, that is, special situations where changes such as road construction and accidents occur.

In an aspect, a method of handling an external abnormality in an autonomous driving system, performed in a device including a memory and a processor electrically connected to the memory, includes collecting physical situation information outside an autonomous vehicle from at least one sensor installed in the autonomous vehicle through the processor, repeatedly performing a physical situation perception operation for a preset critical time through the processor, selecting one of a plurality of operation modes according to a result of the physical situation perception operation and generating a route plan for the autonomous vehicle through the processor, and controlling driving of the autonomous vehicle according to the route plan through the processor.

The collecting physical situation information may include collecting surrounding objects, road conditions, and traffic signals outside the vehicle as the physical situation information from a plurality of sensors including a camera, a radar, and a LiDAR.

The collecting physical situation information may include detecting an abnormal situation regarding a malfunction or data loss of at least one of the plurality of sensors, determining a replacement sensor to replace the sensor associated with the abnormal situation among the remaining sensors, and determining whether to replace the sensor on the basis of the possibility of replacing the replacement sensor.

The repeatedly performing a physical situation perception operation may include repeatedly performing at least one of object recognition, obstacle detection, road condition analysis, and traffic signal analysis on the basis of the physical situation information.

The generating a route plan may include generating a movement route from a current vehicle position to a destination and regenerating the movement route by predicting a potential risk related to the physical situation information.

The generating a route plan may include generating a precise route plan on the basis of precise physical situation perception information during a normal mode.

The generating a route plan may include generating a safe route plan for guaranteeing at least safety on the basis of raw physical situation information during a backup mode.

The controlling driving may include determining the critical time by calculating a maximum execution time of a physical situation perception process of initiating a backup mode among the plurality of operation modes.

The controlling driving may include determining a driving situation of the autonomous vehicle on the basis of the physical situation information and calculating the maximum execution time by applying a situation weight based on driving difficulty according to the driving situation.

In another aspect, a device for handling an external abnormality in an autonomous driving system includes a data collection module configured to collect physical situation information outside an autonomous vehicle from at least one sensor installed in the autonomous vehicle, a physical situation perception module configured to repeatedly perform a physical situation perception operation for a preset critical time, a route planning module configured to select one of a plurality of operation modes according to a result of the physical situation perception operation and generate a route plan for the autonomous vehicle, and a control module configured to control driving of the autonomous vehicle according to the route plan.

### Advantageous Effects

The disclosed technology may have the following effects. However, it does not mean that a specific embodiment must include all or only the following effects, and therefore, the scope of the disclosed technology should not be understood as being limited thereby.

The method and device for handling an external abnormality in an autonomous driving system according to one embodiment of the present disclosure can guarantee minimum safety of autonomous driving even in an external abnormality situation that was not predicted at a design stage according to minimum safety guarantee characteristics of a backup mode, and can significantly reduce the possibility of an accident by preventing potential risks due to physical situation perception failure during driving in advance.

In addition, the present disclosure can guarantee minimum safety even in an autonomous driving system with low computational capabilities through commercialization of an autonomous driving system according to safety guarantee in a low-performance computing device, and can aid in commercializing an autonomous driving system by applying autonomous driving technology to a wider range of vehicles at low cost. Furthermore, the present disclosure can improve user reliability through a safety guarantee mechanism and promote the introduction of an autonomous driving system through social awareness improvement.

### BRIEF DESCRIPTION OF THE DRAWINGS

FIG. 1 is a diagram illustrating an external abnormality handling system according to the present disclosure.

FIG. 2 is a diagram illustrating a system configuration of an external abnormality handing device of FIG. 1.

FIG. 3 is a diagram illustrating a functional configuration of a processor of FIG. 2.

FIG. 4 is a flowchart illustrating a method of handling an external abnormality in an autonomous driving system according to the present disclosure.

FIG. 5 is a diagram illustrating an embodiment of a system configuration according to the present disclosure.

FIG. 6 is a diagram illustrating an embodiment of a system operation process according to the present disclosure.

### DETAILED DESCRIPTION

A description of the present disclosure is merely an embodiment for a structural or functional description and the scope of the present disclosure should not be construed as being limited by an embodiment described in a text. That is, since the embodiment can be variously changed and have various forms, the scope of the present disclosure should be understood to include equivalents capable of realizing the technical spirit. Further, it should be understood that since a specific embodiment should include all objects or effects or include only the effect, the scope of the present disclosure is limited by the object or effect.

Meanwhile, meanings of terms described in the present application should be understood as follows.

The terms “first,” “second,” and the like are used to differentiate a certain component from other components, but the scope of should not be construed to be limited by the terms. For example, a first component may be referred to as a second component, and similarly, the second component may be referred to as the first component.

It should be understood that, when it is described that a component is “connected to” another component, the component may be directly connected to another component or a third component may be present therebetween. In contrast, it should be understood that, when it is described that an element is “directly connected to” another element, it is understood that no element is present between the element and another element. Meanwhile, other expressions describing the relationship of the components, that is, expressions such as “between” and “directly between” or “adjacent to” and “directly adjacent to” should be similarly interpreted.

It is to be understood that the singular expression encompasses a plurality of expressions unless the context clearly dictates otherwise and it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In each step, reference numerals (e.g., a, b, c, etc.) are used for convenience of description, the reference numerals are not used to describe the order of the steps and unless otherwise stated, it may occur differently from the order specified. That is, the respective steps may be performed similarly to the specified order, performed substantially simultaneously, and performed in an opposite order.

The present disclosure can be implemented as a computer-readable code on a computer-readable recording medium and the computer-readable recording medium includes all types of recording devices for storing data that can be read by a computer system. Examples of the computer readable recording medium may include a ROM, a RAM, a CD-ROM, a magnetic tape, a floppy disk, an optical data storage device, and the like. Further, the computer readable recording media may be stored and executed as codes which may be distributed in the computer system connected through a network and read by a computer in a distribution method.

If it is not contrarily defined, all terms used herein have the same meanings as those generally understood by those skilled in the art. Terms which are defined in a generally used dictionary should be interpreted to have the same meanings as the meanings in the context of the related art, and are not interpreted as ideal meanings or excessively formal meanings unless clearly defined in the present application.

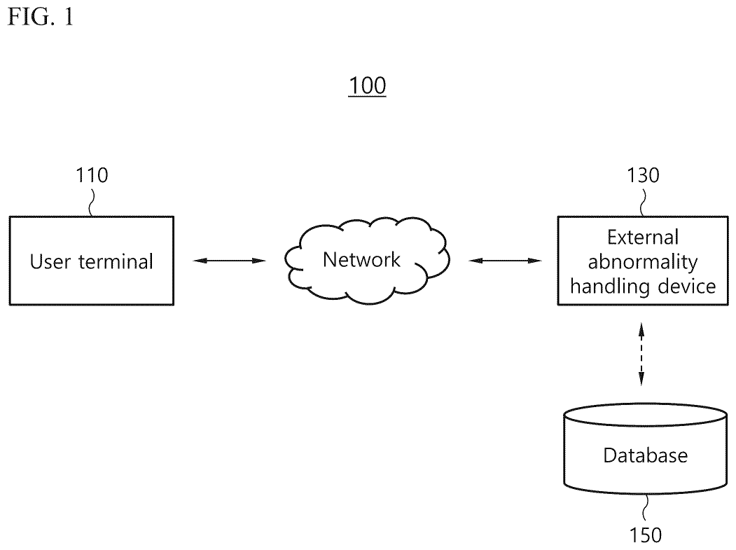

FIG. 1 is a diagram illustrating an external abnormality handling system according to the present disclosure.

Referring to FIG. 1, the external abnormality handling system 100 may include a user terminal 110, an external abnormality handling device 130, and a database 150.

The user terminal 110 is operated by a user and may correspond to a computing device that can transmit data using a network or use a specific service. For example, the user terminal 110 may correspond to a device installed in an autonomous vehicle of an autonomous driving system according to the present disclosure. The user terminal 110 may be implemented as a terminal that provides a driver interface such as a touchscreen or a head-up display (HUD), an entertainment system that provides a high-definition display or audio, and a safety system that performs emergency situation notification or driver status monitoring, but the user terminal 110 is not necessarily limited thereto.

In addition, the user terminal 110 may be implemented as a single device that constitutes the external abnormality handling system 100 according to the present disclosure, and the external abnormality handling system 100 may be implemented in various forms depending on the purpose of handling external abnormality of the autonomous driving system.

The user terminal 110 may be connected to the external abnormality handling device 130 through a network, and a plurality of user terminals 110 may be connected to the external abnormality handling device 130 simultaneously. The user terminal may install and execute a dedicated program or application for linking with the external abnormality handling device 130.

The external abnormality handling device 130 may be implemented as a computer or a server that performs a method of handling an external abnormality in an autonomous driving system according to the present disclosure. For example, the external abnormality handling device 130 may be implemented by being included in an autonomous driving system of an autonomous vehicle or may be implemented by being included in an autonomous driving server that is linked with the autonomous vehicle.

In addition, the external abnormality handling device 130 may be connected to the user terminal 110 through a wired network or a wireless network such as Bluetooth, Wi-Fi, or LTE and may transmit/receive data to/from the user terminal 110 through the network. In addition, the external abnormality handling device 130 may be implemented to operate by being connected to an independent external system (not shown in FIG. 1).

The database 150 may be a storage device that stores various types of information required for the operation of the external abnormality handling device 130. The database 150 may store external physical situation information measured by various sensors and an artificial intelligence model for physical situation perception operation. The database 150 is not necessarily limited thereto, and may store information collected or processed in various forms during the process in which the external abnormality handling device 130 performs the method of handling external abnormality for the autonomous driving system.

In FIG. 1, the database 150 is depicted as a device independent from the external abnormality handling device 130, but the database 150 is not necessarily limited thereto, and may be implemented as a logical storage device included in the external abnormality handling device 130.

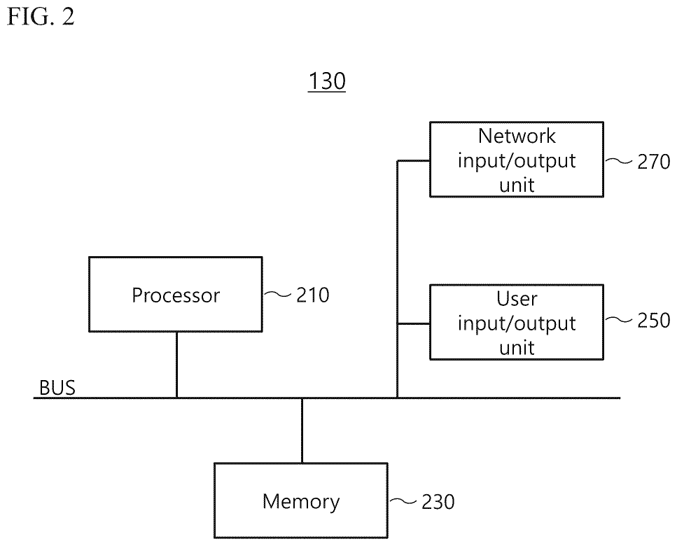

FIG. 2 is a diagram illustrating a system configuration of the external abnormality handling device of FIG. 1.

Referring to FIG. 2, the external abnormality handling device 130 may include a processor 210, a memory 230, a user input/output unit 250, and a network input/output unit 270.

The processor 210 may execute a procedure of handling an external abnormality in an autonomous driving system according to an embodiment of the present disclosure, may manage the memory 230 from/to which data is read or written during this process, and may schedule a synchronization time between a volatile memory and a nonvolatile memory in the memory 230. The processor 210 may control the overall operation of the external abnormality handling device 130, and may be electrically connected to the memory 230, the user input/output unit 250, and the network input/output unit 270 to control a data flow therebetween. The processor 210 may be implemented as a central processing unit (CPU) or a graphics processing unit (GPU) of the external abnormality handling device 130.

The memory 230 may include an auxiliary memory device implemented as a nonvolatile memory such as a solid state disk (SSD) or a hard disk drive (HDD) and used to store data required for the external abnormality handling device 130, and may include a main memory device implemented as a volatile memory such as a random access memory (RAM). In addition, the memory 230 may store a set of instructions for executing the method of handling external abnormality for the autonomous driving system according to the present disclosure by being executed by the processor 210 electrically connected thereto.

The user input/output unit 250 may include an environment for receiving user input and an environment for outputting specific information to the user, and may include, for example, an input device including an adapter such as a touch pad, a touch screen, an on-screen keyboard, or a pointing device, and an output device including an adapter such as a monitor or a touchscreen. In an embodiment, the user input/output unit 250 may correspond to a computing device connected through remote connection, and in such a case, the external abnormality handling device 130 may operate as an independent server.

The network input/output unit 270 provides a communication environment for connecting to the user terminal 110 through a network, and may include, for example, an adapter for communication, such as a local area network (LAN), a metropolitan area network (MAN), a wide area network (WAN), and a value added network (VAN). In addition, the network input/output unit 270 may be implemented to provide a short-distance communication function such as Wi-Fi or Bluetooth or a wireless communication function of 4G or higher for wireless transmission of data.

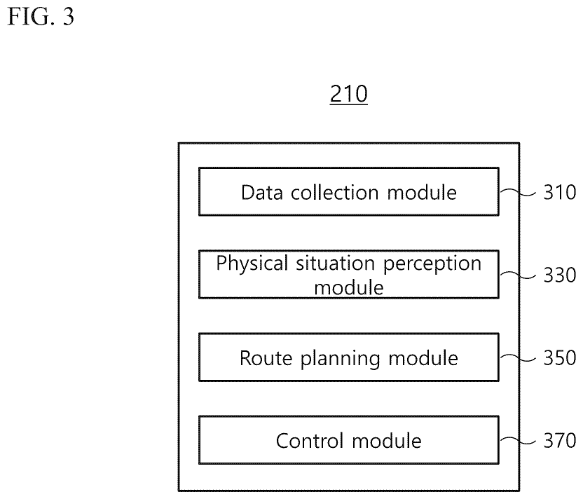

FIG. 3 is a diagram illustrating a functional configuration of the processor of FIG. 2.

Referring to FIG. 3, the external abnormality handling device 130 may perform the method of handling external abnormality for the autonomous driving system according to the present disclosure through the processor 210. To this end, the processor 210 may include a data collection module 310, a physical situation perception module 330, a route planning module 350, and a control module 370 as functional components.

Here, embodiments of the present disclosure do not have to include all of the functional components mentioned above at the same time, and some of the functional components mentioned above may be omitted or some or all of the functional components mentioned above may be selectively included according to each embodiment. The operation of each component is described below in detail.

The data collection module 310 may collect physical situation information outside the autonomous vehicle from at least one sensor installed in the autonomous vehicle. Here, the physical situation information may include surrounding vehicle information, pedestrian information, road situation information, and environment information. For example, the surrounding vehicle information may include the type, location, speed, direction, and driving status of each vehicle. The pedestrian information may include the location, speed, direction, and behavior pattern of each pedestrian. The road situation information may include lanes, road types, and traffic signals. The environment information may include weather, visibility, and road conditions. The data collection module 310 may perform an operation of collecting sensor data from sensors of the autonomous vehicle and preprocessing the sensor data, and generate and store physical situation information through data analysis.

In an embodiment, the data collection module 310 may collect surrounding objects, road conditions, and traffic signals outside the vehicle as physical situation information from a plurality of sensors including a camera, a radar, and a LiDAR. The plurality of sensors may include a camera, a radar, and a LiDAR, and may further include a GPS and an IMU. The data collection module 310 may collect visual information about vehicles, pedestrians, road signs, and traffic facilities outside the vehicle through the camera. The data collection module 310 may detect objects outside the vehicle through the radar and collect distance and speed information of the objects. In this case, objects outside the vehicle may include other vehicles, pedestrians, and obstacles. The data collection module 310 may collect 3D information outside the vehicle through the LiDAR. The LiDAR may be used to measure the distance of a surrounding environment using a laser. In particular, the LiDAR, similar to a camera, can detect surrounding objects and then generate 3D information such as the location and shape of each object. Physical situation information collected by the data collection module 310 may be transferred to the physical situation perception module 330 and used in the subsequent physical situation perception step.

In an embodiment, the data collection module 310 may detect an abnormal situation regarding malfunction or data loss of at least one of a plurality of sensors, determine a replacement sensor that replaces the sensor associated with the abnormal situation among the remaining sensors, and determine whether to replace the sensor based on the possibility of replacing the replacement sensor. First, the data collection module 310 may collect and analyze each sensor data in real time to detect an abnormal situation. The data collection module 310 may check the validity, reliability, abnormal value, data range, and data omission of each piece of sensor data to check data integrity. The data collection module 310 may verify the possibility of malfunction of a sensor itself, and may detect data inconsistency and loss by comparing different pieces of sensor data for the same object.

In addition, when an abnormal situation of sensor data is detected, the data collection module 310 may determine an optimal replacement sensor among the remaining sensors that are not related to the abnormal situation. The data collection module 310 may generate a list of sensors available in the current environment and determine a replacement sensor in consideration of data suitability, sensor locations and directions, system performance, etc. Thereafter, the data collection module 310 may calculate the replaceability of the replacement sensor and finally determine whether to replace the sensor.

For example, the data collection module 310 may generate a list of replacement sensors including a radar and a rear camera when a malfunction occurs in a camera sensor of an autonomous vehicle. The data collection module 310 may calculate the replaceability of each of the radar and the rear camera in consideration of data suitability, sensor location and direction, and system performance impact. If the replaceability of the radar is calculated as 70%, the replaceability of the rear camera is calculated as 50%, and a preset critical value is 60%, the data collection module 310 can finally determine the radar exceeding the critical value as a replacement sensor to replace the camera sensor.

The physical situation perception module 330 may repeatedly perform a physical situation perception operation for a preset critical time. Here, the physical situation perception operation may correspond to an operation of recognizing the external environment around the vehicle in order to perform a decision for safe driving during the driving process of the autonomous vehicle. The physical situation perception module 330 may repeatedly perform the physical situation perception operation during driving of the autonomous vehicle, and the repeating operation may continue until the preset critical time elapses. At this time, the critical time may be preset in consideration of a data processing speed, a rate of change in the surrounding environment, and the system performance.

In an embodiment, the physical situation perception module 330 may repeatedly perform at least one operation among object recognition, obstacle detection, road condition analysis, and traffic signal analysis on the basis of physical situation information. The physical situation perception module 330 may perform the physical situation perception operation by applying various algorithms. For example, the object recognition operation may be performed based on an object recognition algorithm. The object recognition algorithm may correspond to a technique for identifying and classifying objects in images or videos, and may be implemented through a deep learning-based convolutional neural network (CNN). The physical situation perception module 330 may apply the object recognition algorithm to an image of the surrounding environment to identify and classify objects such as vehicles, pedestrians, and bicycles in the image.

In addition, the physical situation perception module 330 may analyze data collected through radar and LiDAR sensors to detect surrounding vehicles or obstacles and identify their locations. The physical situation perception module 330 may apply a road condition analysis algorithm to a road surface image to evaluate the road surface condition and detect abnormalities such as cracks or potholes. The physical situation perception module 330 may apply a traffic signal analysis algorithm to analyze the colors and patterns of traffic signals and then extract information about the traffic signals. For example, the physical situation perception module 330 may identify the color of a traffic signal from an image of the traffic signal and extract status information about the traffic signal.

The route planning module 350 may generate a route plan for the autonomous vehicle by selecting one of a plurality of operation modes on the basis of a result of the physical situation perception operation. That is, the route planning module 350 may generate a route plan by planning a driving route for the autonomous vehicle to move to a specific location. In particular, the route planning module 350 may independently perform an operation of generating a route plan according to an operation mode defined based on a recognized external driving environment of the vehicle. Specifically, the route planning module 350 may support safe driving of the autonomous vehicle by distinguishing between a normal mode and a backup mode and planning a route on the basis of precise information and minimum information.

In an embodiment, the route planning module 350 may generate a movement route from the current vehicle location to a destination and regenerate a movement route by predicting potential risks regarding physical situation information. The route planning module 350 may plan a route for safely and efficiently controlling the autonomous vehicle to the destination. That is, the route planning module 350 may generate an optimal movement route from the current vehicle location to the destination, and may detect potential risk factors occurring during driving to regenerate a movement route for safety. The route planning module 350 may utilize map information to generate a movement route to the destination, and may generate an optimal movement route in consideration of the current location, speed and direction of the vehicle, surrounding vehicle and pedestrian situations, etc. The route planning module 350 may calculate an expected arrival time of each movement route to provide various route options to the user, and may generate a movement route that reflects user's preferences as needed.

In addition, the route planning module 350 may detect potential risk factors that may occur during driving on the basis of physical situation information. For example, potential risks may include road risks such as traffic accidents, road construction, and illegal parking, vehicle risks such as sudden braking, lane changes, and drowsy driving, and pedestrian risks such as jaywalking and road workers. The route planning module 350 may predict potential risks in real time on the basis of physical situation information, and may regenerate a movement route to update the existing route plan.

In an embodiment, the route planning module 350 may generate a precise route plan based on precise physical situation perception information in the normal mode. The normal mode may correspond to an operation mode that is executed based on the existing precise physical situation perception information. The route planning module 350 may generate a route plan based on high accuracy and detailed information during the normal mode. That is, the route planning module 350 may optimize the driving route of the vehicle on the basis of precise environmental information collected from sensors such as the radar, the camera, and the LiDAR. For example, the route planning module 350 may plan an optimal route for safely passing through an intersection by using detailed information such as the color and location of a traffic light detected from the camera, the speed and distance of a preceding vehicle detected from the radar, and the locations and shapes of surrounding obstacles detected from the LiDAR.

In an embodiment, the route planning module 350 may generate a safe route plan that ensures at least safety on the basis of raw physical situation information during the backup mode. The backup mode may correspond to an operation mode that is activated when precise physical situation perception information is not provided or is inaccurate. The route planning module 350 may generate a route plan based on raw physical situation information directly provided by the data collection module 310 during the backup mode. That is, the route planning module 350 may plan a route by focusing on ensuring a minimum level of safety rather than accuracy. For example, the route planning module 350 may roughly recognize the surrounding environment using only the presence and distance information of obstacles detected by the radar and plan a safe route for vehicle driving. The route planning module 350 may generate a route that avoids a collision by adjusting the direction of the vehicle only when there is a surrounding obstacle.

The control module 370 may control driving of the autonomous vehicle according to a route plan. The control module 370 may control driving of the autonomous vehicle along a driving route generated by the route planning module 350. To this end, the control module 370 may generate and execute control inputs such as acceleration, deceleration, and steering wheel operation of the autonomous vehicle in order to control driving of the autonomous vehicle to the destination on the driving route.

In an embodiment, the control module 370 may calculate a maximum execution time of a physical situation perception process that initiates the backup mode among the plurality of operation modes to determine a critical time. That is, the control module 370 may determine a maximum execution time of the physical situation perception module 330 as the critical time in order to rapidly respond to road conditions that change in real time. If the accuracy of physical situation perception does not reach a reference accuracy within the critical time, the control module 370 may control the route planning module 350 to operate according to the backup mode.

For example, if sudden braking of a surrounding vehicle is detected in the normal mode, the physical situation perception module 330 may have difficulty rapidly and accurately recognizing the risk of collision with the surrounding vehicle through a repetitive process. Therefore, the control module 370 may set the critical time to 0.5 seconds, and control the route planning module 350 to initiate the backup mode when the critical time elapses to perform safe stop or route change.

In an embodiment, the control module 370 may determine the driving situation of the autonomous vehicle on the basis of physical situation information and calculate a maximum execution time by applying a situation weight based on a driving difficulty according to the driving situation. The control module 370 may analyze physical situation information such as the locations and speeds of surrounding vehicles, road condition, and traffic signals to determine a driving situation of a driving route according to the route plan. The control module 370 may evaluate the driving difficulty by considering various driving situations such as road environments, traffic conditions, and vehicle speeds. In addition, the control module 370 may calculate a situation weight that reflects the importance of the physical situation perception process according to the driving difficulty.

For example, a high situation weight may be applied to driving situations that are evaluated as having high driving difficulty, such as traffic congestion, complex road sections, unpaved or wet road sections, and bad weather conditions such as rain, snow, and fog, and accordingly, a relatively short maximum execution time may be set. As another example, a low situation weight may be applied to driving situations that are evaluated as having low driving difficulty, such as open highways, road sections with low vehicle density, and good weather conditions, and accordingly, a relatively long maximum execution time may be set.

In an embodiment, the control module 370 may define situation variables regarding the driving situation and calculate a driving difficulty in a specific range based on the situation variables. For example, if the situation variables regarding the driving situation are defined as traffic congestion a1, road condition a2, weather condition a3, road type a4, and intersection/lane change a5, the control module 370 may calculate driving difficulty=‘w1*a1+w2*a2+w3*a3+w4*a4+w5*a5’ (where w1 to w5 are weights for the respective situation variables), and the driving difficulty may be expressed by being adjusted within a range from 1 to 10.

In an embodiment, if a basic execution time of the physical situation perception process is set, the control module 370 may calculate the maximum execution time by applying a situation weight to the basic execution time. That is, the control module 370 may optimize the maximum execution time in consideration of system performance, safety, and efficiency. For example, in the case of city driving, the driving difficulty may be evaluated as high, and as a result of applying a situation weight of 1.5 to the basic execution time of 0.5 seconds, the maximum execution time may be set to 0.5*1.5=0.75 seconds. As another example, in the case of highway driving, the driving difficulty may be evaluated as low, and as a result of applying a situation weight of 0.8 to the basic execution time of 0.5 seconds, the maximum execution time may be set to 0.5*0.8=0.4 seconds.

In an embodiment, the control module 370 may determine a driving situation on the basis of physical situation information and may calculate a situation weight according to the driving situation by utilizing a deep learning model. Here, the deep learning model may correspond to an artificial intelligence model constructed to receive a feature vector regarding physical situation information as an input and generate a situation weight regarding a driving situation as an output. Input data of the deep learning model may include a vehicle speed, surrounding vehicle information (distance, speed, direction, etc.), road condition information (number of lanes, traffic signals, road curvature, etc.), pedestrian information (location, speed, direction, etc.), and weather information (precipitation, visibility, etc.), and output data may be represented as a weight value defined within a specific range.

For example, the control module 370 may calculate a situation weight according to a driving situation using a CNN-based deep learning model that receives a camera image as input data and outputs a situation weight represented as a real value between 0 and 1. As another example, the control module 370 may calculate a situation weight according to a driving situation using an RNN-based deep learning model that receives a LiDAR sensor data represented as sequence data of surrounding vehicle distance, speed, and direction information as input data and outputs a situation weight represented as a real value between 0 and 1.

In addition, the control module 370 may control the overall operation of the processor 210 and manage a control flow or a data flow between the data collection module 310, the physical situation perception module 330, and the route planning module 350.

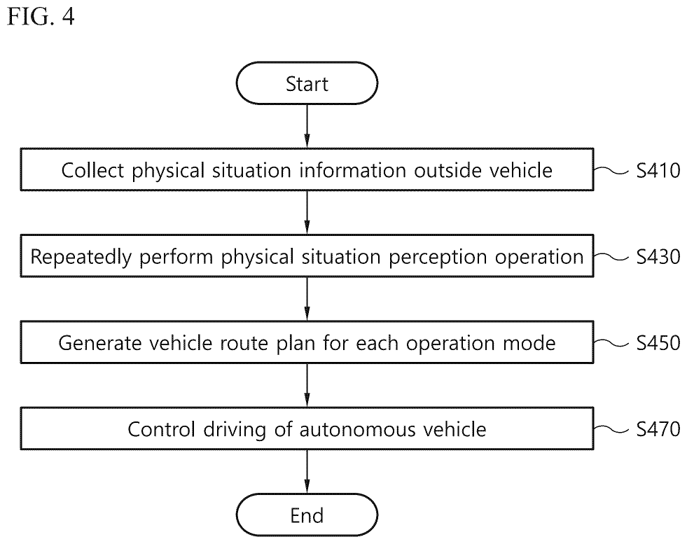

FIG. 4 is a flowchart illustrating a method of handling external abnormality in an autonomous driving system according to the present disclosure.

Referring to FIG. 4, the external abnormality handling device 130 may collect physical situation information outside the vehicle from at least one sensor installed in the autonomous vehicle through the processor 210 (step S410). The external abnormality handling device 130 may repeatedly perform a physical situation perception operation for a preset critical time through the processor 210 (step S430).

In addition, the external abnormality handling device 130 may select one of a plurality of operation modes according to the result of the physical situation perception operation through the processor 210 and generate a route plan for the autonomous vehicle (step S450). The external abnormality handling device 130 may control driving of the autonomous vehicle according to the route plan through the processor 210 (step S470).

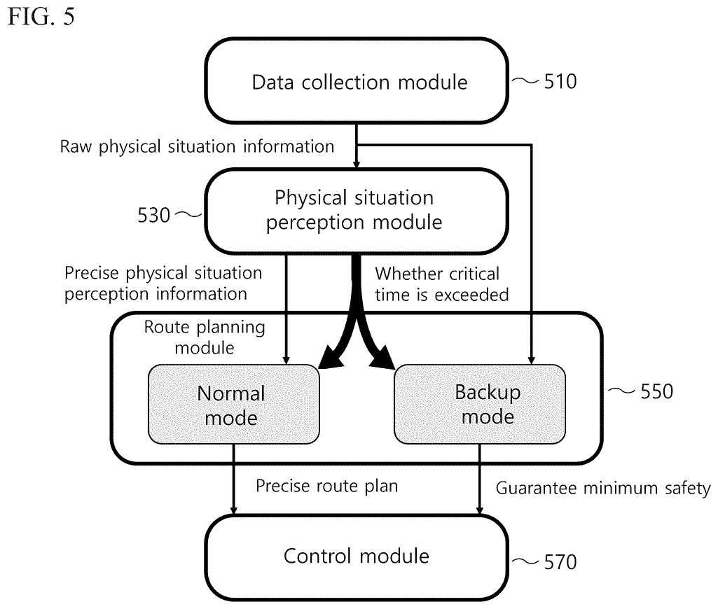

FIG. 5 is a diagram illustrating an embodiment of a system configuration according to the present disclosure.

Referring to FIG. 5, the external abnormality handling system 100 according to the present disclosure may perform an external abnormality handling method through the external abnormality handling device 130. The external abnormality handling device 130 may can be implemented by including a plurality of modules to perform the external abnormality handling method.

More specifically, a data collection module 510 may collect external physical situation information through a sensor installed in an autonomous vehicle. A control module 570 may calculate a maximum execution time of a route planning module 550 that can execute a backup mode and set the same as a critical time of a physical situation perception process.

A physical situation perception module 530 may repeatedly perform a physical situation perception operation until a target accuracy is reached to increase the accuracy, but the execution time may be limited by the critical time. That is, if the target accuracy is not reached by the physical situation perception module 530 by the corresponding time, execution of the physical situation perception module 530 is terminated and the route planning module 550 may be executed in the backup mode.

The route planning module 550 may be designed in two operation modes: a normal mode that is executed based on existing precise physical situation perception information, and a backup mode that is somewhat inaccurate and only guarantees minimum safety but does not require precise physical situation perception information. The route planning module 550 may perform route planning at a level that can guarantee minimum safety using raw physical situation information directly provided by the data collection module 310 during the backup mode.

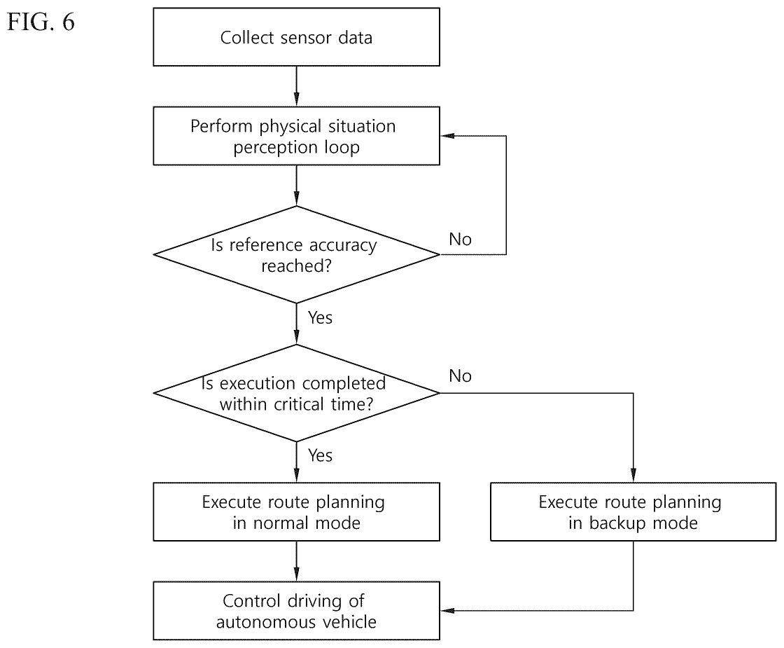

FIG. 6 is a diagram illustrating an embodiment of a system operation process according to the present disclosure.

Referring to FIG. 6, the external abnormality handling method according to the present disclosure may ensure minimum safety by adding a backup mode to the route planning module in preparation for a perception failure situation of the physical situation perception module due to an external abnormality. More specifically, the external abnormality handling device 130 may collect sensor data on physical situation information outside the autonomous vehicle from at least one sensor installed in the autonomous vehicle. The external abnormality handling device 130 may repeatedly perform a physical situation perception operation on the basis of the collected sensor data.

Here, the physical situation perception operation may be repeatedly performed until a preset reference accuracy is reached. Here, an accuracy evaluation operation regarding the physical situation perception operation may be performed based on the repeated performance result, and an accuracy measurement index and an evaluation algorithm for operation evaluation may be defined in advance. That is, the physical situation perception module may perform the physical situation perception operation and then apply the operation result to the evaluation algorithm to calculate an accuracy measurement index. The physical situation perception module may determine whether the calculated accuracy measurement index satisfies the reference accuracy.

If the reference accuracy is not reached until the critical time elapses, the external abnormality handling device 130 may execute route planning in the backup mode. If the reference accuracy is reached within the critical time and execution of the physical situation perception operation is completed, the external abnormality handling device 130 may execute route planning in the normal mode. That is, the external abnormality handling device 130 can execute precision route planning based on existing precise physical situation perception information in the normal mode to provide efficient driving of the autonomous vehicle, and can guarantee minimum safety of autonomous driving even in an external abnormal situation that was not predicted in the design stage with minimum safety guarantee characteristics of the backup mode.

Although the preferred embodiments of the present disclosure have been described above, it will be understood by those skilled in the art that the present disclosure can be modified and changed in various manners within the scope that does not depart from the spirit and scope of the present disclosure described in the scope of the following claims.

What is claimed is:

1. A method of handling an external abnormality in an autonomous driving system, performed in a device including a memory and a processor electrically connected to the memory, the method comprising:
collecting physical situation information outside an autonomous vehicle from at least one sensor installed in the autonomous vehicle through the processor;
repeatedly performing a physical situation perception operation for a preset critical time through the processor;
selecting one of a plurality of operation modes according to a result of the physical situation perception operation and generating a route plan for the autonomous vehicle through the processor; and
controlling driving of the autonomous vehicle according to the route plan through the processor.

2. The method of claim 1, wherein the collecting physical situation information comprises collecting surrounding objects, road conditions, and traffic signals outside the vehicle as the physical situation information from a plurality of sensors including a camera, a radar, and a LiDAR.

3. The method of claim 2, wherein the collecting physical situation information comprises detecting an abnormal situation regarding a malfunction or data loss of at least one of the plurality of sensors, determining a replacement sensor to replace the sensor associated with the abnormal situation among the remaining sensors, and determining whether to replace the sensor on the basis of the possibility of replacing the replacement sensor.

4. The method of claim 1, wherein the repeatedly performing a physical situation perception operation comprises repeatedly performing at least one of object recognition, obstacle detection, road condition analysis, and traffic signal analysis on the basis of the physical situation information.

5. The method of claim 1, wherein the generating a route plan comprises generating a movement route from a current vehicle position to a destination and regenerating the movement route by predicting a potential risk related to the physical situation information.

6. The method of claim 1, wherein the generating a route plan comprises generating a precise route plan on the basis of precise physical situation perception information during a normal mode.

7. The method of claim 1, wherein the generating a route plan comprises generating a safe route plan for guaranteeing at least safety on the basis of raw physical situation information during a backup mode.

8. The method of claim 1, wherein the controlling driving comprises determining the critical time by calculating a maximum execution time of a physical situation perception process of initiating a backup mode among the plurality of operation modes.

9. The method of claim 8, wherein the controlling driving comprises determining a driving situation of the autonomous vehicle on the basis of the physical situation information and calculating the maximum execution time by applying a situation weight based on driving difficulty according to the driving situation.

10. A device for handling an external abnormality in an autonomous driving system, the device comprising:
a data collection module configured to collect physical situation information outside an autonomous vehicle from at least one sensor installed in the autonomous vehicle;
a physical situation perception module configured to repeatedly perform a physical situation perception operation for a preset critical time;
a route planning module configured to select one of a plurality of operation modes according to a result of the physical situation perception operation and generate a route plan for the autonomous vehicle; and
a control module configured to control driving of the autonomous vehicle according to the route plan.
